(19) United States
(12) Patent Application Publication
(10) Pub. No.: US 2021/0235481 A1
(43) Pub. Date: Jul. 29, 2021

(54) USER TERMINAL AND RADIO COMMUNICATION METHOD

(71) Applicant: NTT DOCOMO, INC., Tokyo (JP)

(72) Inventors: Kazuki Takeda, Tokyo (JP); Satoshi Nagata, Tokyo (JP); Lihui Wang, Beijing (CN); Xiaolin Hou, Beijing (CN)

(73) Assignee: NTT DOCOMO, INC., Tokyo (JP)

(21) Appl. No.: 17/053,578

(22) PCT Filed: May 7, 2018
(86) PCT No.: PCT/JP2018/017666

§ 371 Date: Nov. 6, 2020

(51) Int. Cl. H04W 72/12; H04W 72/04; H04L 5/00

(52) U.S. Cl. CPC H04W 72/1289; H04L 5/0053; H04W 72/0446

(57) ABSTRACT

To appropriately execute a process of receiving downlink control information or a process of transmitting data even when a slot configuration is quasi-statically or dynamically configured, an aspect of a user terminal of the present disclosure includes a receiving section that receives, via a downlink control channel, downlink control information that is used for scheduling of a physical shared channel, and a control section that controls a process of receiving certain downlink control information based on a slot format and a candidate slot offset that is used to determine a slot in which the physical shared channel is transmitted.

### TECHNICAL FIELD

The present invention relates to a user terminal and a radio communication method in a next generation mobile communication system.

### BACKGROUND ART

In UMTS (Universal Mobile Telecommunications System) networks, Long Term Evolution (LTE) was specified for purposes of higher data rates, lower latency, and the like (Non Patent Literature 1). In addition, LTE-A (LTE-Advanced, LTE Rel. 10, 11, 12, and 13) was specified for purposes of, for example, larger capacity and more sophisticated one as compared to LTE (LTE Rel. 8 and 9).

Successor systems of LTE (for example, FRA (Future Radio Access), 5G (5th generation mobile communication system), 5G+ (plus), NR (New Radio), MX (New radio access), and FX (Future generation radio access), and also referred to as LTE Rel. 14 or 15 or later and the like) have also been studded.

In existing LIE systems (for example, LTE Rel. 8 to 13), a 1 ms sub-frame (also referred to as transmission time interval (TTI) or the like) is used to perform downlink (DL) and/or uplink (UL) communications. The sub-frame is a transmission time unit of a channel-coded one data packet and is a processing unit for scheduling, link adaptation, retransmission control (HARQ: Hybrid Automatic Repeat reQuest), or the like.

A radio base station (for example, eNB (eNodeB)) controls data allocation (scheduling) to a user terminal (Ox: user equipment) and provides a data scheduling instruction to the UE by using downlink control information (DCI). When, for example, a UE compliant with the existing LIE (for example, LIE Rel. 8 to 13) receives DCI indicating an instruction for UL transmission (also referred to as UL grant), the Pb transmits UL data in a sub-frame a predetermined period later (for example, 4 ms later).

### CITATION LIST

### Non Patent Literature

NPL 1: 3GPP TS 36.300 V8.12.0 “Evolved Universal Terrestrial Radio Access (E-UIRA) and Evolved Universal Terrestrial Radio Access Network (E-UTRAN) ; Overall description; Stage 2 (Release 8)”, April 2010

### SUMMARY OF INVENTION

### Technical Problem

It has been studied to, in future radio communication systems (for example, NR), control the scheduling of data on a certain period (for example, slot) basis. Alternatively, it has also been studied to control the scheduling of data by the one or more symbols (for example, referred to as mini-slots) included in each slot.

It is also assumed to, in NR, execute control by quasi-statically or dynamically changing a UL-DL configuration by using at least one of upper layer signaling and downlink control information. A UL-DL configuration may be read as a slot configuration or a slot format.

When a slot configuration is quasi-statically or dynamically changed and configured, it is a challenge of how to control a process of receiving (for example, monitoring) DCI that is used for the scheduling of data or the like or a process of transmitting data. When it is not possible to appropriately control the process of receiving DCI or the process of transmitting data, there are concerns that communication quality deteriorates.

It is an object of the present disclosure to provide user terminal and a radio communication method that are capable of appropriately executing a process of receiving downlink control information or a process of transmitting data even when a slot configuration is quasi-statically or dynamically configured.

### Solution to Problem

A user terminal according to an aspect of the present disclosure includes a receiving section that receives, via a downlink control channel, downlink control information that is used for scheduling of a physical shared channel, and a control section that controls a process of receiving certain downlink control information based on a slot format and a candidate slot offset that is used to determine a slot in which the physical shared channel is transmitted.

### Advantageous Effects of Invention

According to the present invention, even when a slot configuration is quasi-statically or dynamically configured, it is possible to appropriately execute a process of receiving downlink control information or a process of transmitting data.

### BRIEF DESCRIPTION OF DRAWINGS

FIG. 1 is a diagram showing an example of scheduling of a PUSCH by using a slot offset.

FIG. 2 is a diagram showing an example of a slot format that is quasi-statically or dynamically configured.

FIG. 3 is a diagram showing an example of control for monitoring certain DCI.

FIG. 4 is a diagram showing an example of interpretation of certain DCI.

FIG. 5 is a diagram showing another example of interpretation of certain DCI.

FIG. 6 is a diagram showing another example of control for monitoring certain DCI.

FIG. 7 is a diagram showing another example of control for monitoring certain DCI.

FIG. 8 is a diagram showing an example of the schematic configuration of a radio communication system according to an embodiment of the present invention.

FIG. 9 is a diagram showing an example of the overall configuration of a radio base station according to the embodiment of the present invention.

FIG. 10 is a diagram showing an example of the functional configuration of the radio base station according to the embodiment of the present invention.

FIG. 11 is a diagram showing an example of the overall configuration of a user terminal according to the embodiment of the present invention.

FIG. 12 is a diagram showing an example of the functional configuration of the user terminal according to the embodiment of the present invention.

FIG. 13 is a diagram showing an example of the hardware configuration of each of the radio base station and the user terminal according to the embodiment of the present invention.

### DESCRIPTION OF EMBODIMENTS

It has been studied to, in a future radio communication system (hereinafter, also referred to as NR), based on downlink control information (hereinafter, also referred to as DCI) that is transmitted in a certain slot, control the scheduling of a physical shared channel in another slot. For example, based on DCI that is transmitted in slot #n, an uplink shared channel (also referred to as PUSCH) in slot #n+1 or later is scheduled.

A slot in which a UE transmits PUSCH (or a slot in which a PUSCH is scheduled by using DCI) may be determined based on a slot offset. A slot offset (for example, also referred to as K₂) may be provided from a base station to a UE. A base station may, for example, configure one or more candidate slot offsets to a UE by using an upper layer (for example, RRC signaling or the like) and indicate a certain slot offset in the UE by using DCI. Similarly, a base station may determine a slot in which a UE receives a PDSCH based on a slot offset. A slot offset (for example, also referred to as K₀) that is used to receive a PDSCH may be provided from a base station to a UE.

A base station may configure candidate combinations of information indicating the start symbol (S) and data length (L) of PUSCH (SLIV: start and length indicator value) and a PUSCH mapping type in a UE in addition to a slot offset. A base station may, for example, configure a table in which. multiple candidate combinations of slot offset, SLIV, and PUSCH mapping type are defined (also referred to as SLIV table or PUSCH symbol allocation table) in a UE.

An SLIV table is defined in N rows. A candidate combination of candidate combination index, slot offset indicated by the index, start symbol (S) and data length (L) of PUSCH, and mapping type is defined in each row. When a base station configures a table by using upper layer signaling, it may be sufficient that the base station provides a row number of the N-row SLIV table to a UE by using DCI to schedule a PUSCH.

A UE determines PUSCH allocation resources (for example, a slot, an allocation symbol in the slot, and the like) of a PUSCH to be scheduled by using the DCI based on a certain field contained in the DCI. A certain field may be referred to as time-domain resource allocation field.

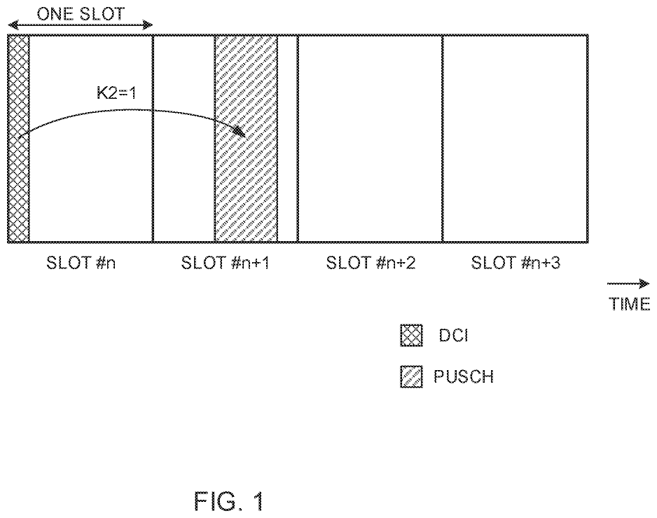

When, for example, the slot offset (K₂) is configured to one, a UE transmits a PUSCH in slot #n+1 based on DCI received in slot #n (see FIG. 1). The slot offset (K₂) is not limited to one and may be configured from among various integers greater than or equal to zero.

The UE also executes a reception process by monitoring DCI (for example, DCI format) in a monitored region of a downlink control channel. A monitored region of a downlink control channel is also referred to as monitoring occasion, monitoring window, or monitoring opportunity.

A monitoring occasion of a PDCCH may be determined based on at least one of a monitoring periodicity, a monitoring offset, and a monitoring pattern, which are provided from a base station. A UE may determine a monitoring occasion based on, for example, a monitoring periodicity, a monitoring offset, and a monitoring pattern, which are configured by using an upper layer (for example, RRC signaling) from a base station. A monitoring occasion may be configured for each DCI format.

Incidentally, in the NR, it is possible to quasi-statically or dynamically configure the UL-DL configuration of each slot. A UL-DL configuration may be referred to as slot configuration, slot format, UL-DL assignment, or the like. A transmission direction may be determined by the symbol contained in each slot. Any one of UL transmission, DL transmission, and flexible transmission is configured as a transmission direction. In the NR, it is also possible to determine any one of UL transmission, DL transmission, and flexible transmission based on individual channel/signal allocation by means of upper layer signaling or physical layer signaling without configuring the UL-DL configuration of each slot.

A base station, for example, quasi-statically configures the transmission direction of each slot or symbol contained in each slot (slot format) to UE by using an upper layer (for example, RRC signaling). An upper layer parameter that is used to provide a slot format may be a parameter that is configured in common to a plurality of UEs (for example, UL-DL-configuration-common) or may be a parameter that is individually configured for each UE (for example, UL-DL-configuration-dedicated).

Alternatively, a base station may dynamically configure a slot format in a UE by using DC- (for example, DCI format 2_0).

A UE determines a slot format based on information that is provided from a base station and controls reception of a PDCCH, a PDSCH, or the like and transmission of a PUCCH or a PUSCH.

When a slot format is quasi-statically or dynamically configured in this way, it is a challenge of how to control a process of receiving (for example, monitoring) DCI or a process of transmitting data.

The inventors focused attention on the relationship between a slot offset of a PUSCH that is scheduled by using DCI and a slot format that is quasi-statically or dynamically configured.

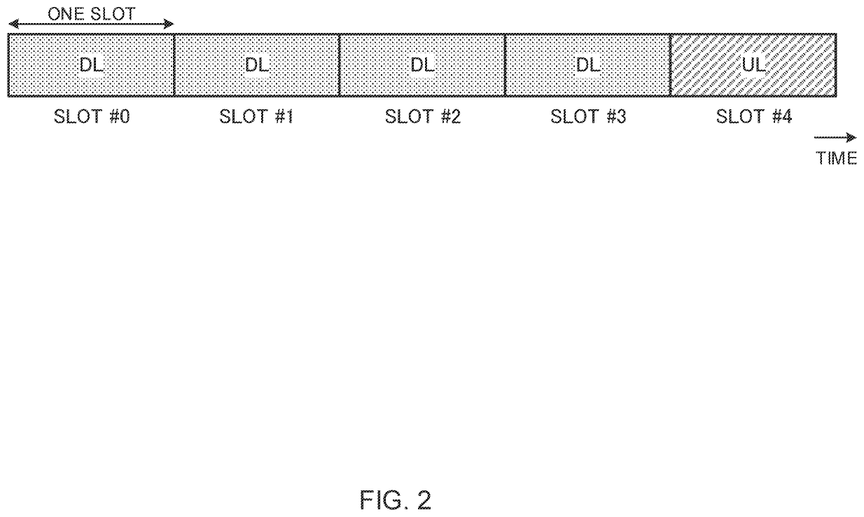

For example, there is a case where, in a certain slot (for example, monitoring occasion), UL transmission may not be configured in a slot corresponding to a candidate slot offset that is configured from a base station. As an example, assuming that one and two (K₂=1 and 2) are configured as candidate slot offsets, slots #0 to #3 are configured for DL (or the slots are not configured for UL transmission available for PUSCH transmission), and UL transmission is contained in slot #4 (see FIG. 2). The candidate slot offsets correspond to multiple candidate slot offsets that are configured in a UE by using an upper layer in advance from a base station.

In this case, it is not possible to schedule a PUSCH in slot #4 by using PDCCH (or DCI) in slot #0 and slot #1. In other words, when the slot offset that can be provided by using DCI is one or two and slot #2 and slot #3 are configured for DL, transmission of PUSCH in slot #4 needs to use PDCCH (or DCI) that is transmitted in slot #2 or slot #3.

The inventors found that, depending on the relationship between a slot offset and a slot format that is quasi-statically or dynamically configured, monitoring of certain DCI to schedule a PUSCH in a certain slot (for example, slot #0 or slot #1 in FIG. 2) is not required. Certain DCI may be, for example, at least one of DCI format 0_0 and DCI format 0_1.

Alternatively, the inventors found that, depending on the relationship between a slot offset and a slot format that is quasi-statically or dynamically configured, changing the interpretation of certain DCI for the scheduling of a PUSCH that is transmitted in a certain slot (for example, slot #0 or slot #1 in FIG. 2) is required. The interpretation of certain DCI for PUSCH scheduling may be a region (for example, a slot or a symbol in a slot) to which a PUSCH is allocated by means of scheduling of the certain DCI.

Hereinafter, embodiments according to the present invention will be described in detail. Components in each embodiment each may be applied solely or may be applied in combination.

In the following description, an example of transmission of UL data (PUSCH) in UL is described; however, a similar configuration may be applied to transmission of another signal (for example, DL data (PDSCH) in DL or HARQ-ACK for DL data).

### First Embodiment

In a first embodiment, a UE controls whether to monitor certain DCI based on a slot format and a slot offset at a monitoring occasion of a PDC CH.

The UE determines a slot format based on at least one of a slot format that is quasi-statically configured from a base station and a slot format that is dynamically configured from the base station. The UE may determine candidate slot offsets for a PUSCH based on a slot offset (for example, K₂) that is quasi-statically configured from the base station.

The UE may, for example, determine a slot format based on a parameter (for example, UL-DL-configuration-common, UL-DL-configuration-dedicated, or the like) that is provided by using an upper layer (for example, RRC signaling). The UE may determine a slot format based on slot format information (SEI) that is provided by using DCI (for example, DCI format 2_0). When SFI is provided by using DCI, a slot format provided by using the upper layer may be overwritten.

The UE may determine candidate slot offsets based on an SLIV table that is configured by using the upper layer. For example, when candidate slot offsets that are configured in the SLAV table configured by using the upper layer are one and two, the UE assumes that candidate transmission timing of a PUSCH that is scheduled by using DCI in slot in is slot #n+1 or slot #n+2.

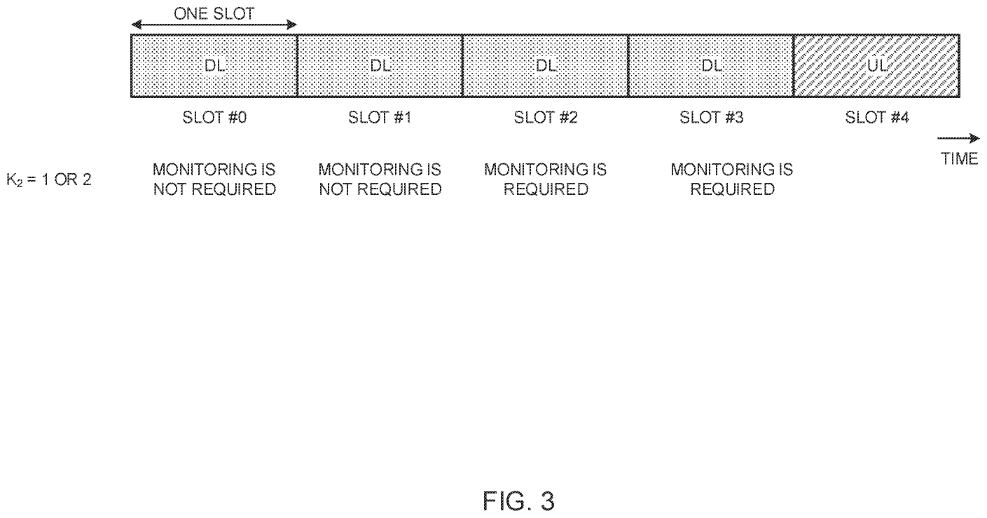

FIG. 3 shows a case where one and two (K₂=1 and 2) are configured as candidate slot offsets, slots #0 to #3 are configured for DL (or the slots are not configured for UL transmission available for PUSCH transmission.), and UL transmission is contained in slot #4. In the following description, the case where one and two are configured as candidate slot offsets will be described; however, candidate slot offsets are not limited to these candidates. In the following description, the case where at least slots #0 to #3 are contained is assumed as a monitoring occasion of a PDCCH; however, the monitoring occasion is not limited thereto.

The UE controls whether to monitor certain DCI at a monitoring occasion based on a slot format and a slot offset of a PUSCH. At least one of DCI format 0_0 and DCI format 0_1 that are used to schedule a PUSCH is used as an example of certain DCI; however, the certain DCI is not limited thereto.

When candidate slot offsets to be configured are one and two, the UE may control not to monitor certain DCI in slot #0 and slot #1. Thus, it is possible to dispense with a decoding process (for example, blind decoding) for a certain DCI format, so a processing load on the UE is reduced.

A DCI format other than certain DCI may be monitored. In this case, the UE may increase the number of times of decoding for other DCI formats (or candidate PDCCHs).

For example, in the slot or PDCCH monitoring period, it is assumed that the number of candidate PDCCHs that can be monitored in the cell (or the bandwidth part (BWP)) is X. The UE determines X candidate PDCCHs to be monitored in consideration of one or multiple search spaces configured in the cell or the bandwidth part. At this time, when the number of configured candidate PDCCHs is greater than or equal to X, the UE does not monitor (drops) candidate PDCCHs exceeding X based on a certain rule. Therefore, when the UE does not monitor certain DC1, it is possible to reduce opportunities to drop other DCI formats, by determining X candidate PDCCHs in consideration of the fact that the UE does not monitor the DCI.

On the other hand, the UE determines that certain DCI to schedule a PUSCH in slot #4 may be transmitted in slot #2 and slot #3, and controls to monitor certain DCI.

In this way, by controlling whether to monitor certain DCI based on a slot format and a slot offset at a monitoring occasion of a PDCCH, it is possible to appropriately control monitoring of DCI and improve communication quality.

### Second Embodiment

In a second embodiment, a UE controls the interpretation of certain DCI based on a slot format and a slot offset at a monitoring occasion of a PDCCH. The interpretation of certain DCI may be read as, for example, the value of a slot offset (for example, K₂), a slot to which certain DCI is applied, or an allocation region (for example, time domain) of a PUSCH that is scheduled by using certain DCI.

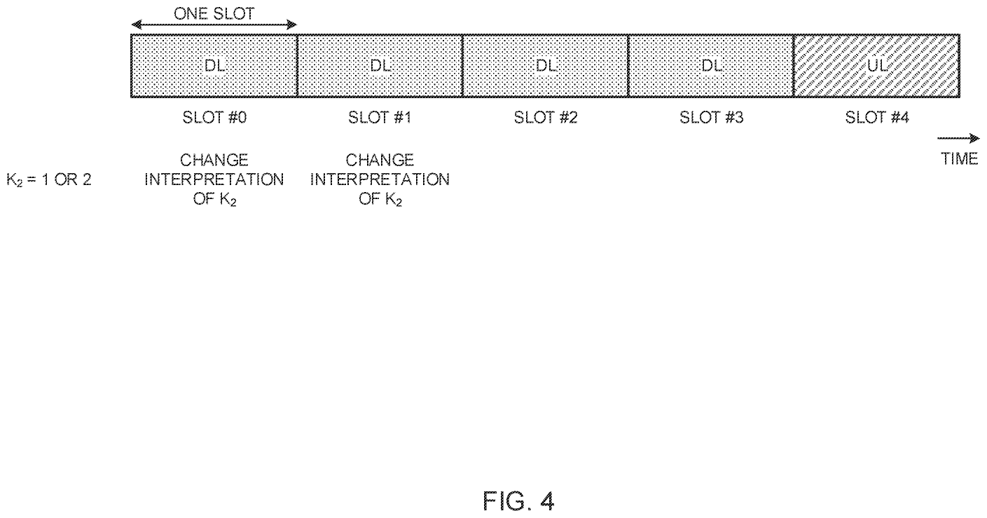

FIG. 4 shows a case where one and two (K₂=1 and 2) are configured as candidate slot offsets, slots #0 to #3 are configured for DL (or the slots are not configured for UI transmission available for PUSCH transmission), and UL transmission is contained in slot #4. In the following description, the case where one and two are configured as candidate slot offsets will be described; however, candidate slot offsets are not limited to these candidates. In the following description, the case where at least slots #0 to #3 are contained is assumed as a monitoring occasion of a PDCCH; however, the monitoring occasion is not limited thereto.

The UE controls the interpretation of certain DCI at a monitoring occasion based on a slot format and candidate slot offsets of a PUSCH. At least one of DCI format 0_0 and DCI format 0_1 that are used to schedule a PUSCH is used as an example of certain DCI; however, the certain DCI is not limited thereto.

When candidate slot offsets to be configured are one and two, the UE changes the interpretation of certain DCI detected in slot #0 and slot #1. When, for example, the UE detects certain DCI in slot #0 and slot #1, the UE may ignore a slot offset indicated by the certain DCI and transmit PUSCH based on the certain DCI in a certain slot. A certain slot may be a slot in which UL transmission is performed for the first time after certain DCI is received or the number of slots exceeding a configured value of K₂ after certain DCI is received (slot #4 in FIG. 4) or a slot from which PUSCH transmission resources are obtained for the first time based on SLIV configured by using the DCI.

It may be read that not the UE ignores a slot offset that is indicated by certain DCI but a slot offset that is indicated by certain DCI indicates a certain slot.

In this way, the transmission timing of certain DCI is flexibly controlled by changing the interpretation of the certain DCI in a certain slot (for example, slot #0 or slot #1 in FIG. 4) based on a slot format and candidate slot offsets of a PUSCH. Transmission of a PUSCH is appropriately controlled by changing the interpretation of certain DCI in a certain slot (for example, slot #0 or slot #1 in FIG. 4) based on a slot format and candidate slot offsets of a PUSCH.

Even when slots #2 and #3 are not configured for DL transmission in a UE (for example, configured for flexible transmission by using SFI), it is possible to transmit a PUSCH in slot #4 by transmitting certain DCI in slot #0 or slot #1.

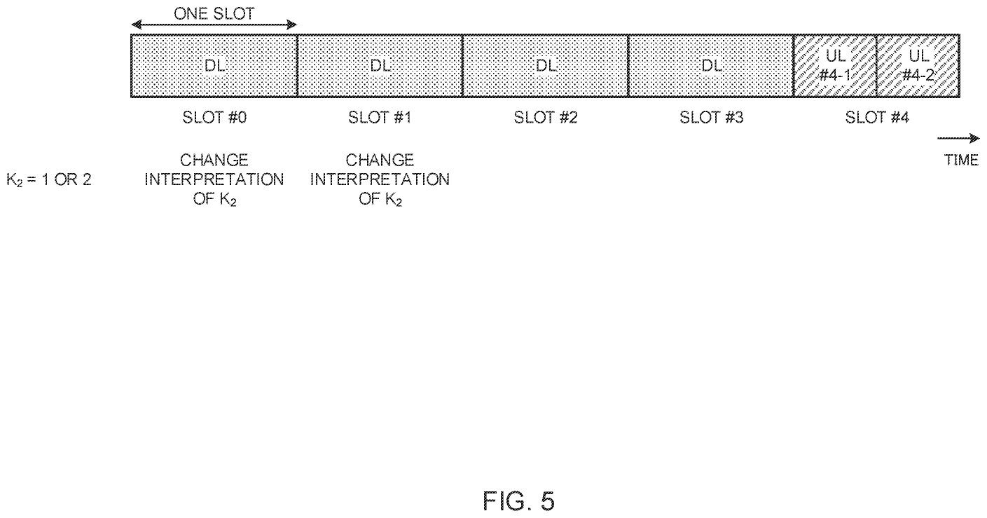

When a UE has multiple UL transmission opportunities in slot #4, the UE may control the time domain of a PUSCH in slot #4 based on a slot offset (K2) that is indicated by certain DCI in slot #0 or slot #1 (see FIG. 5). FIG. 5 shows a case where two UL transmission opportunities (#4-1, #4-2) are configured in slot #4; however, the number of UL transmission opportunities is not limited thereto. For example, the number of UL transmission opportunities in slot 44 may be three or more (for example, four) or may be configured based on the values of candidate slot offsets (for example, a maximum value to be configured, or the like).

For example, when a slot offset (K₂) that is indicated by certain DCI in slot #0 or slot #1 one, a UK transmits a PUSCH at the transmission opportunity (#4-1) at which transmission is enabled first in slot #4. When a slot offset (K₂) that is indicated by certain DCI in slot #0 or slot #1 is two, a UE transmits a PUSCH at the transmission opportunity (#4-2) at which transmission is enabled first in slot #4.

Thus, allocation of the time domain of a PUSCH in slot 4 is flexibly controlled.

### Modifications

In the first embodiment and the second embodiment, PUSCH transmission is described; however, the present embodiments may be applied to PDSCH transmission or HARQ-ACK transmission for a PDSCH.

<PDSCH Transmission>

For example, in transmission and reception of PDSCH, when a UE receives DCT that is used to schedule a PDSCH, the UE determines a slot to receive a PDSCH based on information indicating a slot offset (also referred to as K₀) contained in the DCI. A base station provides multiple candidate slot offsets to the UE by using upper layer signaling and indicates a specific slot offset (K₀) by using DCI.

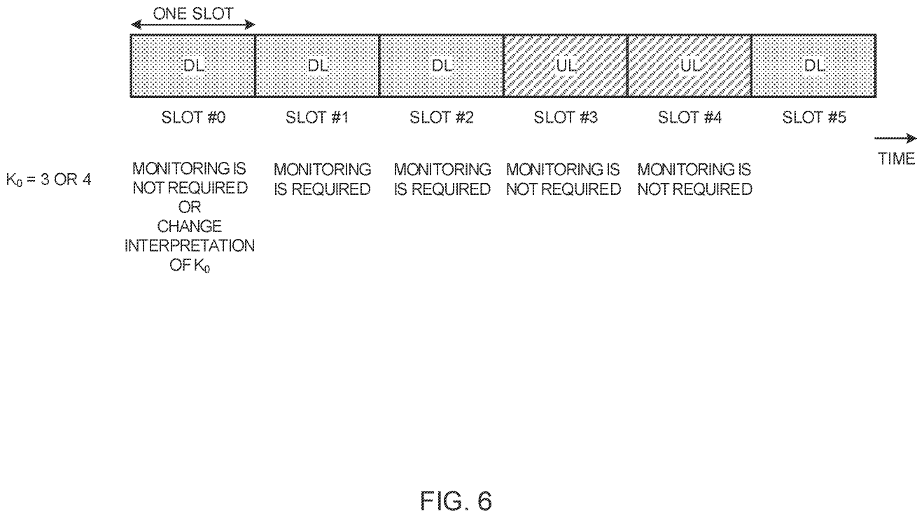

FIG. 6 shows a case where three and four (K₀=3 and 4) are configured as candidate slot offsets, slots #0 to #2, and #5 are configured for DL (or the slots are not configured for DL transmission available for PUSCH transmission), and UL transmission is contained in slots #3 and #4. In the following description, the case where three and four are configured as candidate slot offsets will be described; however, candidate slot offsets are not limited to these candidates in the following description, the case where at least slots #0 to #2, and #5 are contained is assumed as a monitoring occasion of a PDCCH; however, the monitoring occasion is not limited thereto.

The UE controls whether to monitor certain DCI at a monitoring occasion based on a slot format and a slot offset of a PDSCH. At least one of DCI format 1_0 and DCI format 1_1 that are used to schedule a PDSCH is used as an example of certain DCI; however, the certain DCI is not limited thereto.

When candidate slot offsets to be configured are three and four, the UE may control not to monitor certain DCI in slot #0. When DCI that is transmitted in slot #1 indicates a slot offset of four, it is possible to schedule a PDSCH in slot #5. Therefore, the UE may be configured to perform monitoring in slot #1. In this way, by controlling monitoring of a PDCCH based on candidate slot offsets of a PDSCH, a decoding process (for example, blind decoding) for a certain DCI format is not required, so a processing load on the UE is reduced.

Alternatively, in 6, the interpretation of K₀ in slot #1 may be changed and controlled as described in the above second embodiment.

<HARQ-ACK Transmission for PDSCH>

For example, in transmission and reception of a PDSCH, when a UE receives DCI that is used to schedule a PDSCH, the UE determines a slot to transmit HARQ-ACK based on a field to indicate HARQ-ACK timing contained in the DCI. A slot to transmit HARQ-ACK is expressed by the number of offset slots (referred to as K₁) from a slot in which a PDSCH is received. A base station provides multiple candidate slot offsets to the UE by using upper layer signaling and indicates a specific slot offset (K₁) by using DCI.

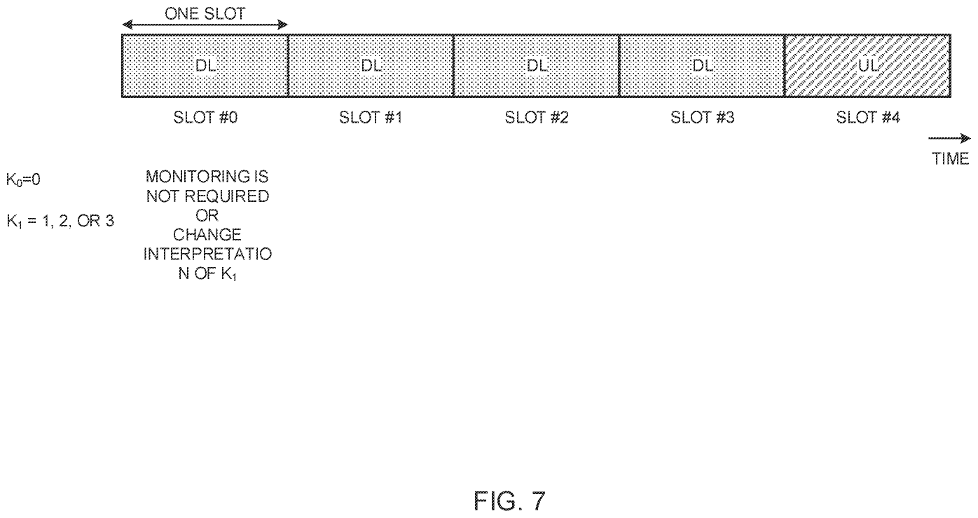

FIG. 7 shows a case where zero (K₀=0) is configured as a slot offset of a PDSCH, one, two, and three (K₁=1, 2, and 3) are configured as candidate HAR)-ACK timings, slots #0 to #3 are configured for DL (or the slots are not configured for DL transmission available for PUSCH Transmission), and UL transmission is contained in slot #4. In the following description, the case where one, two, and three are configured as candidate slot offsets will be described; however, candidate slot offsets are not limited to these candidates in the following description, the case where at least slots #0 to #3 are contained is assumed as a monitoring occasion of a PDCCH; however, the monitoring occasion is not limited thereto.

The UE controls whether to monitor certain DCI at a monitoring occasion based on a slot format, a slot offset (K₀) of a PDSCH, and a slot offset (K₁) of HARQ-ACK. At least one of DCI format 1_0 and DCI format 1_1 that are used to schedule a PDSCH is used as an example of certain DCI; however, the certain DCI is not limited thereto.

When candidate HARQ-ACK timings to be configured are one, two, and three, a UE may control not to monitor certain DCI in slot #0. This is because, even if a PDSCH is allocated in slot #0, there are no UL resources to transmit HARQ-ACK for the PDSCH. In this way, by controlling to monitor a PDCCH based on candidate slot offsets (K₀) of a PDSCH and a slot offset (K₁) of HARQ-ACK, a decoding process (for example, blind decoding) for a certain DCI format is not required, so a processing load on the UE is reduced.

Alternatively, in FIG. 7, the interpretation of K₁ in slot #0 may be changed and controlled as described in the above second embodiment.

(Radio Communication System)

Hereinafter, the configuration of a radio communication system according to an embodiment of the present invention will be described. In this radio communication system, communications are performed by using any one or any combination of the radio communication methods according to the above-described embodiments of the present invention.

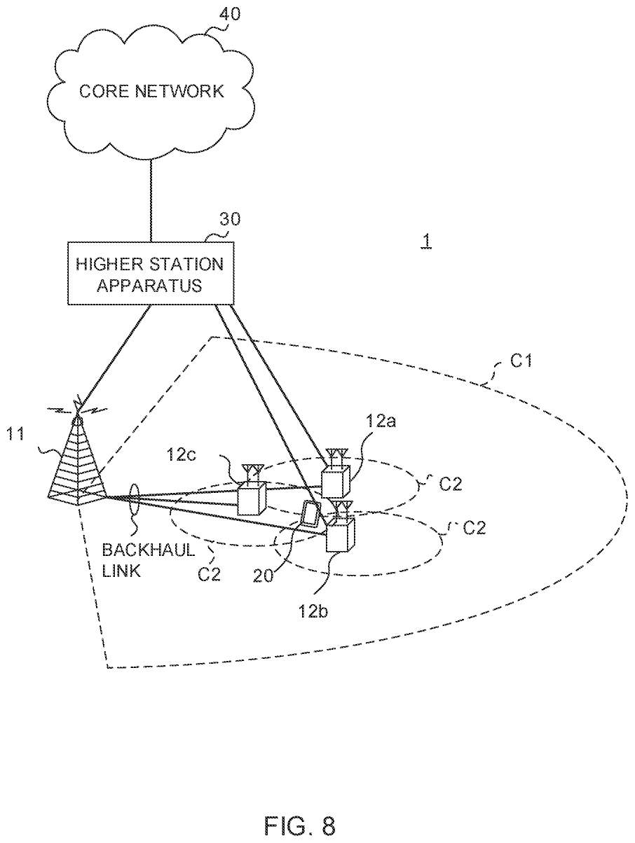

FIG. 8 is a diagram showing an example of the schematic configuration of the radio communication system according to the embodiment of the present invention. In the radio communication system 1, it is possible to apply carrier aggregation and/or dual connectivity (DC) that integrates multiple fundamental frequency blocks (component carriers) each having a system bandwidth (for example, 20 KHz) of an LTE system as one unit.

The radio communication system 1 may be called LIE (Long Term Evolution), LTE-A (LTE-Advanced), LTE-B (LTE-Beyond), SUPER 3G, IMT-Advanced, 4G (4th generation mobile communication system), 5G (5th generation mobile communication system), NR (New Radio), ERA (Future Radio Access), New-RAT (Radio Access Technology), or the like and may be called a system that implements them.

The radio communication system 1 includes a radio base station 11 that forms a macrocell C1 with a relatively wide coverage, and radio base stations 12 (12a to 12c) that each form a small cell C2 arranged inside the macrocell C1 and narrower than the macrocell C1. A terminal 20 is arranged in the macrocell C1 and the small cells C1. The arrangement and the number of the cells and the user terminals 20 are not limited to the embodiment shown in the drawing.

The user terminal 20 is capable of establishing connection with both the radio base station 11 and each radio base station 12. It is conceivable that the user terminal 20 simultaneously uses the macrocell C1 and the small cells C2 by using CA or DC. The user terminal 20 may amply CA or DC by using multiple cells (CC) (for example, five or less CC, or six or more CC).

The user terminal 20 and the radio base station 11 are capable of communicating with each other by using a carrier with a narrow bandwidth in a relatively low frequency band (for example, 2 GHz) (an existing carrier and also referred to as legacy carrier or the like). On the other hand, the user terminal 20 and each radio base station 12 may use a carrier with a wide bandwidth in a relatively high frequency band (for example, 3.5 GHz, 5 GHz, or the like) or may use the same carrier as the carrier that is used be the user terminal 20 and the radio base station 11. The configuration of frequency bands that are used by the radio base stations is not limited thereto.

The user terminal 20 is capable of performing communications in each cell by using time division duplex (IDE)) and/or frequency division duplex (FCC). In each cell (carrier), a single numerology may be applied or multiple different numerologies may be applied.

The radio base station 11 and each radio base station (or the two radio base stations 12) may be connected by wire (for example, optical fibers, an X2 interface, or the like compliant with CPRI (Common Pubic Radio Interface)) or wirelessly.

The radio base station 11 and the radio base stations 12 each are connected to a higher station apparatus 30 and is further connected to a core network 40 via the higher station apparatus 30. Examples of the higher station apparatus 30 include an access gateway apparatus, a radio network controller (RNC), and a mobility management entity (MME); however, the higher station apparatus 30 is not limited thereto. The radio base stations 12 may be connected to the higher station apparatus 30 via the radio base station 11.

The radio base station 11 is a radio base station with a relatively wide coverage and may be referred to as macro base station, aggregation node, eNE (eNodeB), transmission/reception point, or the like. Each radio base station 12 is a radio base station with a local coverage and may be referred to as small base station, micro base station, pica base station, femto base station, HeNB (Home eNodeb), RRH (Remote Radio Head), transmission/reception point, or the like. Hereinafter, when the radio base stations 11, 12 are not distinguished from each other, the radio base stations 11, 12 are collectively referred to as radio base stations 10.

The user terminals 20 are terminals that support various communication modes, such as LTE and LTE-A, and may include not only mobile communication terminals (mobile stations) but also fixed communication terminals (fixed stations).

In the radio communication system 1, as radio access modes, orthogonal frequency division multiple access (OFDMA) is applied for downlink, and single carrier frequency division multiple access (SC-FDMA) and/or OFDMA is applied for uplink.

CFDMA a multi-carrier transmission mode that performs communications by dividing a frequency band into multiple narrow frequency bands (sub-carriers) and mapping pieces of data to the sub-carriers SC-FDMA is a single carrier transmission mode that reduces interference between terminals by dividing a system bandwidth into bands composed of one or successive resource blocks for each terminal and causing multiple terminals to use different bands. Uplink and downlink radio access modes are not limited to these combinations, and other radio access modes may be used.

In the radio communication system 1, a downlink shared channel (PDSCH: physical downlink shared channel) that is shared by the user terminals 20, a broadcast channel (PBCH: physical broadcast channel), a downlink L1/L2 control channel, or the like is used as a downlink channel. User data, upper layer control information, an SIB (system. information block.), and the like are transmitted via a PDSCH. An MIB (master information block) is transmitted via a PBCH.

A downlink LI/D2 control channel includes a PD CCH (physical downlink control channel), an EPDCCH (enhanced physical downlink control channel), a PCFICH (physical control format indicator channel), a PHICH (physical hybrid-ARQ indicator channel), and the like. Downlink control information (DCI) containing scheduling information of a PDSCH and/or a PUSCH and other information are transmitted via a PDCCH.

Scheduling information may be provided by using DCI. For example, DCI to schedule DL data reception may be called DL assignment, and DCI to schedule UL data transmission may be called UL grant.

The number of OFEN symbols to be used for a PDCCH is transmitted via a PCFICH Receipt confirmation information of HARD (Hybrid Automatic Repeat reQuest) for a PUSCH (for example, also referred to as retransmission control information, HARD-ACX, ACKINACK, or the like) is transmitted via a PHICH. An EPDCCH is frequency division multiplexed with a PDSCH (downlink shared data channel) and used to transmit DCI and the like as in the case of: a PDCCH.

In the radio communication system 1, an uplink shared channel (PUSCH: physical uplink shared channel) that is shared by the user terminals 20, an uplink control channel (PUCCH: physical uplink control channel), a random access channel (PRACH: physical random access channel), or the like is used as an uplink channel. User data, upper layer control information, and the like are transmitted via a PUSCH Downlink radio quality information (CQI: channel quality Indicator), receipt confirmation information, scheduling request (SR), or the like is transmitted via a PUCCH. A random access preamble for establishing connection with a cell is transmitted via a PRACH. In the radio communication system 1, a cell-specific reference signal (CRS), a channel state information-reference signal (CSI-RS), a demodulation reference signal (DMRS), a positioning reference signal (PRS), or the like is transmitted as a downlink reference signal. In the radio communication system 1, a sounding reference signal (SRS), a demodulation reference signal (DMRS), or the like is transmitted as an uplink reference signal. A DMRS may be referred to as terminal-specific reference signal (UE-specific reference signal). Reference signals to be transmitted are not limited thereto.

(Radio Base Station)

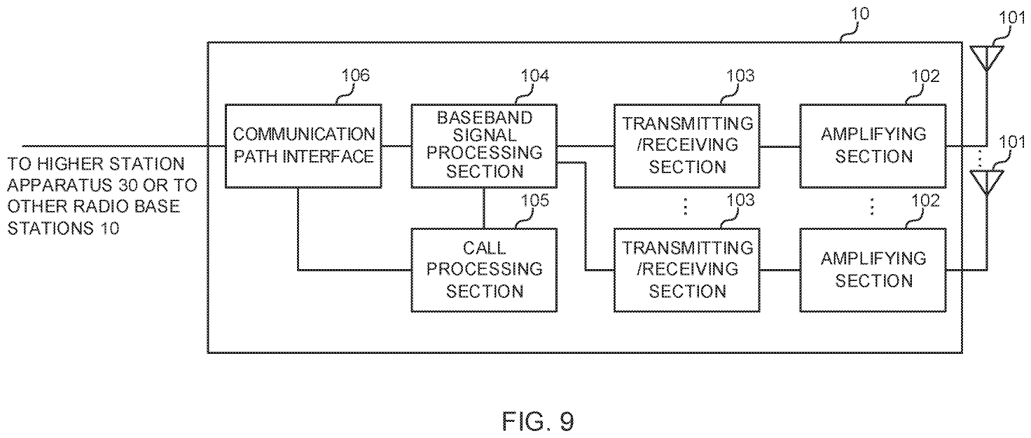

FIG. 9 is a diagram showing an example of the overall configuration of the radio base station according to the embodiment of the present invention. The radio base station 10 includes multiple transmitting/receiving antennas 101, amplifying sections 102, transmitting/receiving sections 103, a baseband signal processing section 104, a call processing section 105, and a communication path interface 106. It is sufficient that the radio base station 10 includes at least one of each of the transmitting/receiving antenna 101, the amplifying section 102, and the transmitting/receiving section 103.

User data that is transmitted from the radio base station 10 to the user terminal 20 by downlink is input from the higher station apparatus 30 to the baseband signal processing section 104 via the communication path interface 106.

In the baseband signal processing section 104, user data is subjected to an RLC layer transmission process, such as a PDCP (packet data convergence protocol) layer process, division and combination of user data, and RIC (Radio Link Control) retransmission control, and a transmission process, such as MAC (Medium Access Control) retransmission control (for example, a HARQ transmission process), scheduling, transmission format selection, channel coding, an inverse Fast Fourier transform (IFFT) process, and a pre-coding process, and is transferred to the transmitting/receiving section 103. A downlink control signal is also subjected to a transmission process, such as channel coding and inverse Fast Fourier transform, and is transferred to the transmitting/receiving section 103.

The transmitting/receiving section 103 converts a baseband signal pre-coded for each antenna and output from the baseband signal processing section 104 into a radio frequency band and transmits a signal in the radio frequency band. The radio frequency signal frequency-converted by the transmitting/receiving section 103 is amplified by the amplifying section 102 and is transmitted from the transmitting/receiving antenna 101. The transmitting/receiving section 103 may be a transmitter/receiver, a transmitting/receiving circuit, or a transmitting/receiving apparatus that is described based on common knowledge in the technical field concerning the present invention. The transmitting/receiving section 103 may be an integrated transmitting/receiving section or may be a pair of transmitting section and receiving section.

On the other hand, for an uplink signal, a radio frequency signal received by the transmitting/receiving antenna 101 is amplified by the amplifying section 102. The transmitting/receiving section 103 receives the uplink signal amplified by the amplifying section 102. The transmitting/receiving section 103 converts the received signal in frequency to a baseband signal and outputs the baseband signal to the baseband signal processing section 104.

In the baseband signal processing section 104, user data contained in the input uplink signal is subjected to a reception process such as a Fast Fourier transform (FFT) process, an inverse discrete Fourier transform (IDFT) process, error correction decoding, and MAC retransmission control, and RLC layer and PDCP layer reception processes, and is transferred to the higher station apparatus 30 via the communication path interface 106. The call processing section 105 executes a process of calling (such as configuration and releasing) a communication channel, status management of the radio base station 10, management of radio resources, and the like.

The communication path interface 106 transmits or receives signals to or from the higher station apparatus 30 via a certain interface. The communication path interface 106 may transmit or receive signals to or from another radio base station 10 via an inter-base station interface (for example, optical fibers or an X2 interface compliant with CPRI (Common Public Radio Interface) (backhaul signaling).

The transmitting/receiving section 103 transmits, via a downlink control channel, downlink control information that is used to schedule a physical shared channel. The transmitting/receiving section 103 may transmit at least one of information on candidate slot offsets, information on monitoring occasion, and information on slot format.

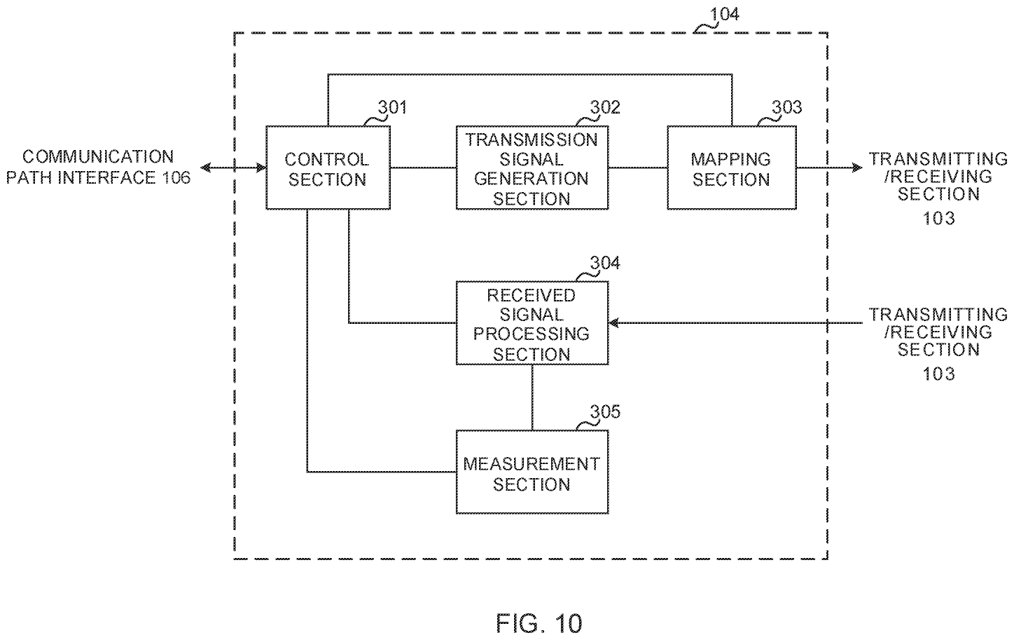

FIG. 10 is a diagram showing an example of the functional configuration of the radio base station according to the embodiment of the present invention. In this example, functional blocks of characterized portions in the present embodiment are mainly shown, and the radio base station 10 may be assumed to include other functional blocks required for radio communication.

The baseband signal processing section 104 includes at least a control section (scheduler) 301, a transmission signal generation section 302, a mapping section 303, a received signal processing section 304, and a measurement section 305. It is sufficient that these components are included in the radio base station 10, and part or all of the components do not need to be included in the baseband signal processing section 104.

The control section (scheduler) 301 generally controls the radio base station 10. The control section 301 may be a controller, a control circuit, or a control apparatus that is described based on common knowledge in the technical field concerning the present invention.

The control section 301 controls, for example, the generation of signal in the transmission signal generation section 302, the allocation of a signal in the mapping section 303, and the like. The control section 301 also controls a process of receiving a signal in the received signal processing section 304, the measurement of a signal in the measurement section 305, and the like.

The control section 301 controls the scheduling (for example, resource allocation) of system information, a downlink data signal (for example, a signal that is transmitted via a PDSCH), a downlink control signal (for example, a signal that is transmitted via a PDCCH and/or an EPDCCH; receipt confirmation information or the like). The control section 301 also controls the generation of a downlink control signal, a downlink data signal, and the like based on a result of determination as to whether retransmission control on an uplink data signal is required, or the like. The control section 301 also controls the scheduling of a synchronization signal (for example, PSS (primary synchronization signal)/SSS (secondary synchronization signal)), a downlink reference signal (for example, CRS, CSI-RS, or DMRS), and the like.

The control section 301 also controls the scheduling of an uplink data signal (for example, a signal that is transmitted via a PUSCH), an uplink control signal (for example, a signal that is transmitted via a PUCCH and/or a PUSCH; receipt confirmation information or the like), a random access preamble (for example, a signal that is transmitted via a PRACH), an uplink reference signal, and the like.

The control section 301 also controls the transmission. of certain downlink control information based on a slot format to be configured in a UE, and candidate slot offsets.

The transmission signal generation section 302 generates a downlink signal (a downlink control signal, a downlink data signal, a downlink reference signal, or the like) and outputs the downlink signal to the mapping section 303 based on an instruction from the control section 301. The transmission signal generation section 302 may be a signal generator, a signal generation circuit, or a signal generation apparatus that is described based on common knowledge in the technical field concerning the present invention.

The transmission signal generation section 302, for example, generates DL assignment that provides downlink data allocation information and/or UL grant that provides uplink data allocation information based on an instruction from the control section 301. DL assignment and UL grant each are DCI and are in accordance with a DCI format. A downlink data signal is encoded and modulated in accordance with an encoding ratio, a modulation mode, and the like determined based on channel state information (CSI) and the like from each user terminal 20.

The mapping section 303 maps a downlink signal generated by the transmission signal generation section 302 to certain radio resources and outputs the downlink signal to the transmitting/receiving section 103 based on an instruction from the control section 301. The mapping section 303 may be a mapper, a mapping circuit, or a mapping apparatus that is described based on common knowledge in the technical field concerning the present invention.

The received signal processing section 304 executes a reception process (for example, demapping, demodulation, decoding, or the like) on a received signal input from the transmitting/receiving section 103. A received signal is, for example, an uplink signal (an uplink control signal, an uplink data signal, an uplink reference signal, or the like) that is transmitted from the user terminal 20. The received signal processing section 304 may be a signal processor, a signal processing circuit, or a signal processing apparatus that is described based on common knowledge in the technical field concerning the present invention.

The received signal processing section 304 outputs information decoded through the reception process to the control section 301. When, for example, the received signal processing section 304 receives a PUCCH containing HARQ-ACK, the received signal processing section 304 outputs HARQ-ACK to the control section 301. The received signal processing section 304 outputs a received signal and/or a signal subjected to the reception process to the measurement section 305.

The measurement section 305 performs a measurement on a received signal. The measurement section 305 may be a measuring instrument, a measurement circuit, or a measurement apparatus that is described based on common knowledge in the technical field concerning the present invention.

The measurement section 305 may, for example, perform RFM (radio resource management) measurement, 531 (channel state information) measurement, or the like based on a received signal. The measurement section 305 may measure a received power (for example, RSRP (reference signal received power)), received quality (for example, RSRQ (reference signal received quality), SINR (signal to interference plus noise ratio), SNR (signal to noise ratio)), signal strength (for example, RSSI (received signal strength indicator)), propagation path information (for example, CSI), or the like measured result may be output to the control section 301.

(User Terminal)

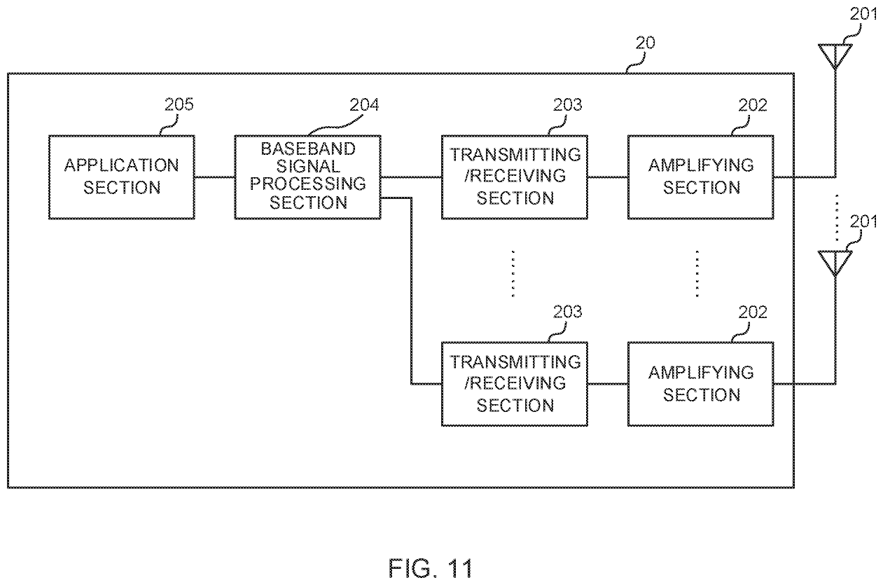

FIG. 11 is a diagram showing an example of the overall configuration of the user terminal according to the embodiment of the present invention. The user terminal 20 includes multiple transmitting/receiving antennas 201, amplifying sections 202, transmitting/receiving sections 203, a baseband signal processing section 204, and an application section 205. It is sufficient that the user terminal 20 includes at least one of each of the transmitting/receiving antenna 201, the amplifying section 202, and the transmitting/receiving section 203.

A radio frequency signal received by the transmitting/receiving antenna 201 is amplified by the amplifying section 202. The transmitting/receiving section 203 receives a downlink signal amplified by the amplifying section 202. The transmitting/receiving section 203 converts the received signal in frequency to a baseband signal and outputs the baseband signal to the baseband signal processing section 204. The transmitting/ receiving section 203 may be a transmitter/receiver, a transmitting/receiving circuit, or a transmitting/receiving apparatus that is described based on common knowledge in the technical field concerning the present invention. The transmitting/receiving section 203 may be an integrated transmitting/receiving section or may be a pair of transmitting section and receiving section.

The baseband signal processing section 204 executes a reception process such as FFT process, error correction decoding, and retransmission control, or the like on the input baseband signal. Downlink user data is transferred to the application section 205. The application section 205 executes a process related to a layer upper than a physical layer and a MAC layer, or other processes. Within downlink data, broadcast information may also be transferred to the application section 205.

On the other hand, uplink user data is input from the application section 205 to the baseband signal processing section 204. In the baseband signal processing section 204, the uplink user data is subjected to a transmission process (for example, HARQ transmission process) of retransmission control, channel coding, pre-coding, a discrete Fourier transform (DFT) process, an IFFT process, and the like and is transferred to the transmitting/receiving section 203, The transmitting/receiving section 203 converts a baseband signal output from the baseband signal processing section 204 into a radio frequency band and transmits a signal in the radio frequency band. The radio frequency signal frequency-converted by the transmitting/ receiving section 203 is amplified by the amplifying section 202 and is transmitted from the transmitting/receiving antenna 201.

The transmitting/receiving section 203 receives, via a downlink control channel, downlink controlling/formation that is used to schedule a physical shared channel. The transmitting/receiving section 203 may receive at least one of information on candidate slot offsets, information on monitoring occasion, and information on slot format.

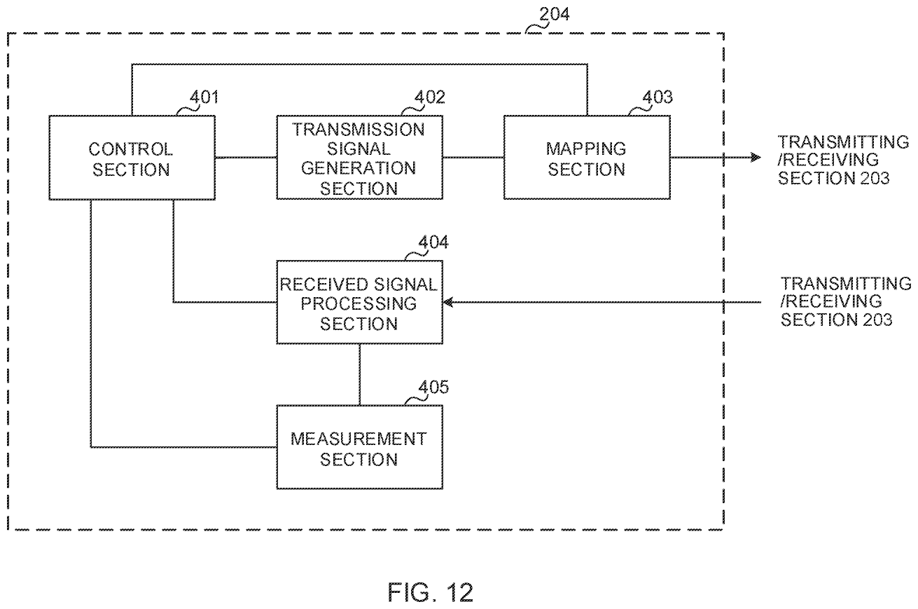

FIG. 12 is a diagram showing an example of the functional configuration of the user terminal according to the embodiment of the present invention. In this example, functional blocks of characterized portions in the present embodiment are mainly shown, and the user terminal 20 may be assumed to include other functional blocks required for radio communication.

The baseband signal processing section 204 of the user terminal 20 includes at least a control section 401, a transmission signal generation section 402, a mapping section 403, a received signal processing section 404, and a measurement section 405. It is sufficient that these components are included in the user terminal 20, and part or all of the components do not need to be included in the baseband signal processing section 204.

The control section 401 generally controls the user terminal 20. The control section 401 may be a controller, a control circuit, or a control apparatus that is described based on common knowledge in the technical field concerning the present invention.

The control section 401 controls, for example, the generation of a signal in the transmission signal generation section 402, the allocation of a signal in the mapping section 403, and the like. The control section 401 also controls a process of receiving a signal in the received signal processing section 404, measurement of a signal in the measurement section 405, and the like.

The control section 401 acquires, from the received signal processing section 404, a downlink control signal and a downlink data signal transmitted from the radio base station 10. The control section 401 controls the generation of an uplink control signal and/or an uplink data signal based on a result of determination as to whether retransmission control on a downlink control signal and/or a downlink data signal required, or the like.

The control section 40l controls the reception process on certain downlink control information based on a slot format and candidate slot offsets that are used to determine a slot in which a physical shared channel is transmitted.

The control section 401, for example, controls whether to monitor certain downlink control information based on a slot format and candidate slot offsets at a monitoring occasion of downlink control channel (see, for example, FIG. 3).

Alternatively, the control section 401 may control the interpretation of a slot offset indicated by certain downlink control information based on a slot format and the candidate slot offsets at a monitoring occasion of a downlink control channel (see, for example, FIG. 4). When, for example, there is no occasion of an uplink shared channel in a certain range corresponding to candidate slot offsets, the control section 401 controls the transmission of an uplink shared channel outside the certain range based on certain downlink control information received at a monitoring occasion.

The transmission signal generation section 402 generates an uplink signal (an uplink control signal, an uplink data signal, an uplink reference signal, or the like) and outputs the downlink signals to the mapping section 403 based on an instruction from the control section 401. The transmission signal generation section 402 may be a signal generator, a signal generation circuit, or a signal generation apparatus that is described based on common knowledge in the technical field concerning the present invention.

The transmission signal generation section 402, for example, generates an uplink control signal related to receipt confirmation information, channel state information (CSI), or the like based on an instruction from the control section 401. The transmission signal generation section 402 also generates an uplink data signal based on an instruction from the control section 401. When, for example, a downlink control signal that is provided from the radio base station 10 contains UL grant, the transmission signal generation section 402 is instructed by the control section 401 to generate an uplink data signal.

The man ping section 403 maps an uplink signal generated by the transmission signal generation section 402 to radio resources and outputs the uplink signal to the transmitting/receiving section 203 based on an instruction from the control section 401. The mapping section 403 may be a mapper, a mapping circuit, or a mapping apparatus that is described based on common knowledge in the technical field concerning the present invention.

The received signal processing section 404 executes a reception process (for example, demapping, demodulation, decoding, or the like) on a received signal input from the transmitting/receiving section 203. A received signal is, for example, a downlink signal (a downlink control signal, a downlink data signal, a downlink reference signal, or the like) that is transmitted from the radio base station 10. The received signal processing section 404 may be a signal processor, a signal processing circuit, or a signal processing apparatus that is described based on common knowledge in the technical field concerning the present invention. The received signal processing section 404 may also be a receiving section according to the present invention.

The received signal processing section 404 outputs information decoded through the reception process to the control section 401. The received signal processing section 404 outputs, for example, broadcast information, system information, RRC signaling, DCI, or the like to the control section 401. The received signal processing section 404 outputs a received signal and/or a signal subjected to the reception process to the measurement section 405.

The measurement section 405 performs a measurement on a. received signal. The measurement section 405 may be a measuring instrument, a measurement circuit, or a measurement apparatus that is described based on common knowledge in the technical field concerning the present invention.

The measurement section 405 may, for example, perform RRM measurement, CSI measurement, or the like based on a received signal. The measurement section 405 may measure a received power (for example, RSRP), received quality (for example, RSRQ, SINR, SNR), signal strength (for example, RSSI), propagation path information (for example, CSI), or the like. A measured result may be output to the control section 401.

(Hardware Configuration)

The block diagrams used to describe the above embodiment show blocks by the function. These functional blocks (components) are implemented by any combination of hardware and/or software. A method of implementing the functional blocks is not limited. In other words, the functional blocks may be implemented by using a single physically and/or logically combined apparatus or may be implemented by directly and/or indirectly connecting two or more physically and/or logically separated apparatuses (by using, for example, wired connection and/or wireless connection) and using these multiple apparatuses.

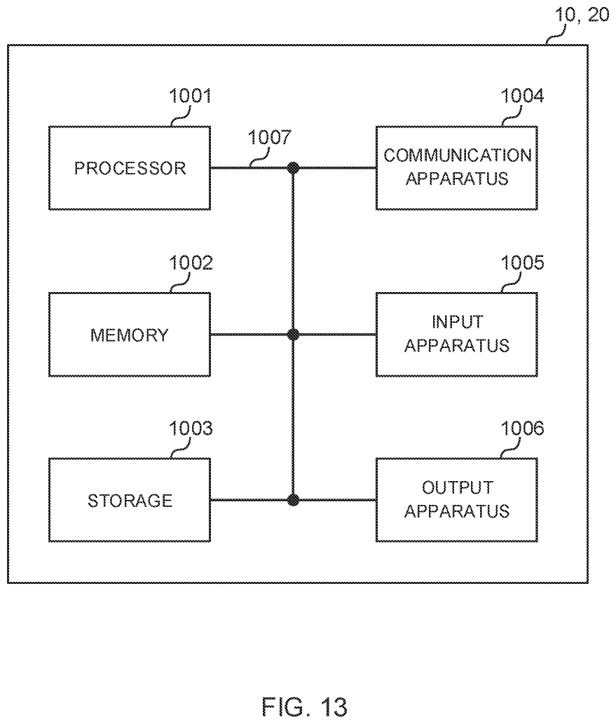

For example, the radio base station, the user terminal, and the like in the embodiment of the present invention may function as a computer that executes a process of the radio communication method of the present invention FIG. 13 is a diagram showing an example of the hardware configuration of each of the radio base station and the user terminal according to the embodiment of the present invention. The above-described radio base station 10 and the user terminal 20 may be physically made as a computer apparatus including a processor 1001, memory 1002, storage 1003, a communication apparatus 1004, an input apparatus 1005, an output apparatus 1006, a bus 1007, and the like.

In the following description, the term “apparatus” may be read as circuit, device, unit, or the like. The hardware configuration of each of the radio base station 10 and the user terminal 20 may be configured to include one or multiple of each of the apparatuses shown in the drawing or may be configured not to include part of the apparatuses.

For example, only one processor 1001 is illustrated; however, multiple processors may be provided. The process may be executed by a single processor or the process may be executed by one or more processors simultaneously, sequentially, or by using other techniques. The processor 1001 may be implemented by one or more chips.

The functions in the radio base station 10 and the user terminal 20 are implemented by, for example, loading certain software (program) onto hardware, such as the processor 1001 and the memory 1002, to cause the processor 1001 to operate, control communications via the communication apparatus 1004, or control the reading and/or writing of data in the memory 1002 and the storage 1003.

The processor 1001, for example, generally controls the computer by running an operating system. The processor 1001 may be a central processing unit (CPU) including an interface with a peripheral apparatus, a control apparatus, an arithmetic apparatus, a register, and the like. For example, the above-described baseband signal processing section 104 (204), the call processing section 105, and the like may be implemented by the processor 1001.

The processor 1001 reads out a program (program code), a software module, data, and the like from the storage 1003 and/or the communication apparatus 1004 onto the memory 1002 and executes various processes in accordance with them. A program that causes a computer to execute at least part of the operations described in the above-described embodiment is used as the program. The control section 401 of the user terminal 20 may be implemented by a control program that is stored in the memory 1002 and that operates on the processor 1001, and the other functional blocks may also be similarly implemented.

The memory 1002 is a computer-readable storage medium and may be at least one of, for example, ROM (read-only memory), EPROM (erasable programmable ROM), EEPROM (electrically EPRGM), RAM (random access memory), and other appropriate storage media. The memory 1002 may be referred to as register, cache, main memory (main storage), or the like. The memory 1002 is capable of saving a program (program code), a software module, or the like that is executable to perform the radio communication method according to the embodiment of the present invention.

The storage 1003 is a computer-readable storage medium and may be at least one of, for example, a flexible disk, a floppy (registered trademark) disk, a magneto-optical disk (for example, a compact disc (CD-ROM (Compact Disc ROM) or the like), a digital versatile disc, a Blu-ray (registered. trademark) disc), a removable disk, a hard disk drive, a smart card, a flash memory device (for example, a card, a stick, or a key drive), a magnetic stripe, a database, a server, and other appropriate storage media. The storage 1003 may be referred to as auxiliary storage.

The communication apparatus 1004 is hardware (transmitting/receiving device) for performing communications between computers via a wired and/or wireless network and is referred to as, for example, network device, network controller, network card, communication module, or the like. The communication apparatus 1004 may be configured to include a radio-frequency switch, a duplexer, a filter, a frequency synthesizer, or the like in order to implement, for example, frequency division duplex (FIM) and/or time division duplex (TDD). For example, the above-described transmitting/receiving antenna 101 (201), the amplifying section 102 (202), the transmitting/receiving section 103 (203), the communication path interface 106, and the like may be implemented by the communication apparatus 1004.

The input apparatus 1005 is an input device that accepts input from an outside (for example, a keyboard, a mouse, a microphone, a switch, a button, a sensor, or the like). The output apparatus 1006 is an output device that performs output to an outside (for example, a display, a speaker, an LED (light emitting diode.) lamp, or the like). The input apparatus 1005 and the output apparatus 1006 may be an integrated component (for example, a touch panel).

The apparatuses such as the processor 1001 and the memory 1002 are connected by the bus 1007 for communicating information. The bus 1007 may be a single bus or may be a set of different buses respectively between apparatuses.

The radio base station 10 and the user terminal 20 each may be configured to include hardware, such as a microprocessor, a digital signal processor (DSP), an ASIC (application specific integrated circuit), a PLD (programmable logic device), and an FPGA (field programmable gate array), and part or all of the functional blocks may be implemented by using the hardware. For example, the processor 1001 may be implemented by using at least one of these pieces of hardware.

The terms described in the specification and/or terms required to understand the specification may be replaced with terms having the same or similar meanings. For example, a channel and/or a symbol may be a signal (signaling). A signal may be a message. A reference signal may be abbreviated as RS (reference signal) and may referred to as to as pilot, pilot signal, or the like depending on a standard applied. A component carrier (CC) may be referred to as cell, frequency carrier, carrier frequency, or the like.

A radio frame may be composed of one or multiple periods (frames) in time domain. Each of the one or multiple periods (frames) that compose a radio frame may be referred to as sub-frame. Furthermore, a sub-frame may be composed of one or multiple slots in time domain. A sub-frame may be a fixed time length (for example, 1 ms) independent of numerology.

Furthermore, a slot may be composed of one or multiple symbols (OFJDM (orthogonal frequency division multiplexing) symbol, SC-FDMA (single carrier frequency division multiple access) symbol, or the like) in time domain. A slot may be a time unit based on numerology. A slot may include multiple mini-slots. Furthermore, each mini-slot may be composed of one or multiple symbols in time domain. A mini-slot may be referred to as sub-slot.

A radio frame, a sub-frame, a slot, a mini-slot, and a symbol all represent a time unit in transmitting signals radio frame, a sub-frame, a slot, a mini-slot, and a symbol may be referred to as other corresponding names. For example, one sub-frame may be referred to as transmission time interval (TTI), multiple successive sub-frames may be referred to as TTI, or one slot or one mini-slot may be referred to as TTI. In other words, a sub-frame and/or a TIT may be a sub-frame (1 ms) in existing LTE or may be a period (for example, 1 to 13 symbols) shorter than 1 ms or may be a period longer than 1 ms. The unit of TTI may be referred to as not sub-frame but slot, mini-slot, or the like.

A TTI means, for example, a minimum scheduling time unit in radio communication. For example, in an LTE system, a radio base station performs scheduling to allocate radio resources (a frequency bandwidth, a transmission power, or the like that user terminals are able to use) to the user terminals on a TTI basis. The definition of TTI is not limited thereto.

A TTI may be a transmission time unit of a channel-coded data packet (transport block), code block, and/or code word or may be a processing unit, such as scheduling and link adaptation. When a TTI is given, a time section (for example, the number of symbols) in which a transport block, a code block, and/or a code word is actually mapped may be shorter than the TTI.

When one slot or one mini-slot is referred to as TTI, one or more TTIs (that is, one or more slots or one or more mini-slots) may be a minimum scheduling time unit. The number of slots (the number of mini-slots) that compose the minimum scheduling time unit may be controlled.

A TTI having a time length of 1 ms may referred to as ordinary TTI (TTI in LTE Rel. 8 to 12), normal TTI, long TTI, ordinary sub-frame, normal sub-frame, long sub-frame, or the like. A TTI shorter than an ordinary TTI may be referred to as shortened TTI, short TTI, partial or fractional TTI, shortened sub-frame, short sub-frame, mini-slot, sub-slot, or the like.

A long TTI (for example, an ordinary TTI, a sub-frame, or the like) may be read as a TTI having a time length exceeding 1 ms. A short TTI (for example, a shortened TTI or the like) may be read as a TTI having a TTI length shorter than the TTI length of a long TTI and longer than or equal to 1 ms.

A resource block (RB) is a resource allocation unit in the time domain and the frequency domain, and may include one or multiple successive sub-carriers in the frequency domain. An RB may include one or multiple symbols in the time domain and may have a length of one slot, one mini-slot, one sub-frame, or one TTI. One TTI and one sub-frame each may be composed of one or multiple resource blocks. One or multiple RBs may be referred to as physical resource block (PRB: physical RB), sub-carrier group (SCG), resource element group (REG), PRB pair, RB pair, or the like.

A resource block may be composed of one or multiple resource elements (RE). For example, one RE may be a radio resource region of one sub-carrier and one symbol.

The structures of the above-described radio frame, sub-frame, slot, mini-slot, symbol, and the like are only illustrative. The configurations of, for example, the number of sub-frames included in a radio frame, the number of slots per sub-frame or per radio frame, the number of mini.-slots included in a slot, the number of symbols and RBs included in a slot or a mini-slot, the number of sub-carriers included in an RB, the number of symbols in a TTI, a symbol length, a cyclic prefix (CP) length, and the like may be variously modified.

Information, parameters, and the like described in the specification may be represented by absolute values or may be represented by relative values relative to certain values or may be represented by other corresponding information. For example, radio resources may be indicated by a certain index.

Names used for parameters and the like in the specification are not restrictive names in all respects. For example, various channels (PUCCH (physical uplink control channel), PDCCH (physical downlink control channel), and the like) and information elements may be identified by any appropriate names, so various names assigned to these various channels and information elements are not restrictive names in all respects.

Information, signals, and the like described in the specification may be represented by using any of various different techniques. For example, data, instruction, command, information, signal, bit, symbol, chip, and the like that can be referred to over the entire description may be represented by voltage, current, electromagnetic wave, magnetic field or magnetic particle, optical field or photon, or any combination of them.

Information, signals, and the like can be output from an upper layer to a lower layer and/or from a lower layer to an upper layer. Information, signals, and the like may be Input or output via multiple network nodes.

Input or output information, signals, and the like may be saved in a specific location (for example, memory) and may be managed by using a management table. Input or output information, signals, and the like can be overwritten, updated, or added. Output information, signals, and the like may be deleted. Input information, signals, and the like may be transmitted to other apparatuses.

Provision of information is not limited to the embodiments described in the specification and may be performed by using other methods. Provision of information may be performed by using, for example, physical layer signaling (for example, downlink control information (DCI) or uplink control information (TJCI)), upper layer signaling (for example, RRC (radio resource control) signaling, broadcast information (master information block (MIB), system information block (SIB), or the like), or MAC (medium access control) signaling), other signals, or any combination of them.

Physical layer signaling may referred to as L1/L2 (Layer 1/Layer 2) control information (L1/L2 control signal), L1 control information (L1 control signal), or the like. RRC signaling may be referred to as RRC message and may be, for example, an RRC connection setup message, an RRC connection reconfiguration message, or the like. MAC signaling may be provided by using, for example, MAC control element (MAC CE).

Provision of certain information (for example, information that it is X) is not limited to explicit provision of information and may be performed implicitly (by, for example, not providing the certain information or providing other information).

A determination may be performed in accordance with value represented by one bit (0 or 1) or may be performed by Boolean represented by true or false or may be performed by numeric comparison (for example, comparison with a certain value).

Software, regardless of whether it is referred to as software, firmware, middleware, microcode, or hardware description language, or other names, should be widely interpreted to mean instruction, instruction set, code, code segment, program code, program, sub-program, software module, application, software application, software package, routine, sub-routine, object, executable file, execution thread, procedure, function, or the like.

Software, instruction, information, or the like may be transmitted or received via transmission media. When, for example, software is transmitted from a website, a server, or other remote sources by using a wired technology (such as a coaxial cable, an optical fiber cable, twisted pair, and a digital subscriber line (DSP)) and/or a wireless technology (such as infrared and microwave), these wired technologies and/or the wireless technologies are included in the definition of transmission media.

The terms “system” and “network.” that are used in the specification are interchangeably used.

In the specification, the terms “base station (BS)”, “radio base station”, “eNB”, “gNB”, “cell”, “sector”, “cell group”, “carrier”, and “component carrier” can be interchangeably used. A base station may be referred to as a term, such as fixed station, NodeB, eNodeB (eNB), access point, transmission point, receiving point, femtocell, and small cell.

A base station may contain one or multiple (for example, three) cells (also referred to as sectors). When a base station contains multiple cells, the overall coverage area of the base station may be divided into multiple smaller areas, and each of the smaller areas is capable of providing communication service by means of a base station sub-system (for example, an indoor small base station (RRH: remote rad head)). The term “cell” or “sector” represents part or all of the coverage area of a base station and/or base station sub-system that provides communication service in the coverage area.

In the specification, the terms “mobile station (MS)”, “user terminal”, “user equipment (UE)”, and “terminal” can be interchangeably used. A base station may be referred to as a term, such as fixed station, Nodeb, eNodeb (eNB), access point, transmission point, receiving point, femtocell, and small cell.

A mobile station may be referred to by persons skilled in the art as subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, client, or some other appropriate terms.

A radio base station in the specification may be read as a user terminal. For example, the embodiments of the present invention may be applied to a configuration in which communications between a radio base station and a user terminal are replaced with (D2D: Device-to-Device) communications between multiple user terminals. In this case, the functions of the above-described radio base station 10 may be provided as the components of the user terminal 20. The terms “uplink”, “downlink”, and the like may be read as “side”. For example, an uplink channel may be read as a side channel.

Similarly, a user terminal in the specification may be read as a radio base station. In this case, the functions of the above-described user terminal 20 may be provided as the components of the radio base station 10.

In the specification, operations that are performed by a base station may be performed by an upper node of the base station. It is apparent that, in a network including one or multiple network nodes including a base station, various operations that are performed to communicate with terminals can be performed by the base station, one or more network nodes (for example, MME (mobility management entity), S-GW (serving-gateway), or the like, is conceivable; however, network nodes are not limited thereto) other than the base station, or any combination of them.

The aspects/embodiments described in the specification may be used solely or may be used in combination or may be switched and used according to execution. The procedures, sequences, flowcharts, and the like described in the specification may be changed in order without any contradiction. For example, for the method described in the specification, elements of various steps are provided in. illustrative order; however, the elements of various steps are not limited to the provided specific order.

The aspects/embodiments described in the specification may be applied to a system that uses LIE (Lona, Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), NR (New Radio), NE (New radio access), FE (Future generation radio access), GSM (registered trademark) (Global System for Mobile communications), CDMA2000, UMB (Ultra Mobile Broadband), IEEE 802.11 Wi-Fi (registered trademark)), IEEE 802.16 (WiMAX (registered trademark)), IEEE 802.20, UWB (Ultra-WideBand), Bluetooth (registered trademark), or other appropriate radio communication methods and/or next generation systems extended based on any one of them.

The phrase “based on” that is used in the specification does not mean “only based on” unless otherwise specified. In other words, the phrase “based on” means both “only based on.” and “at least based on”.

Any reference to an element, using designations such as “first” and “second” that are used in the specification, does not generally limit the quantity or order of those elements. These designations can be used in the specification as a convenient method to distinguish two or more elements from each other. Therefore, references to first and second elements do not mean that only two elements can be employed or the first element must precede the second element in some way.

The term “determining” that is used in the specification may include diverse operations. For example, “determining” may be regarded as determining as to calculating, computing, processing, deriving, investigating, looking up (for example, looking up in a table, a database, or other data structures), ascertaining, or the like. “determining” may also be regarded as determining as to receiving (for example, receiving information), transmitting (for example, transmitting information), input, output, accessing (for example, accessing data in memory), or the like. “Determining” may also be regarded as determining as to resolving, selecting, choosing, establishing, comparing, or the like. In other words, “determining” may be regarded as “determining” some kind of operation.

The terms “connected” and “coupled” that are used in the specification, or all modifications of these terms mean every direct or indirect connection or coupling between two or more elements, and one or more intermediate elements may be included between two elements “connected” or “coupled” to each other. Coupling or connection between elements may be physical, logical, or in combination of them. For example, “connection” may be read as “access”.

In the specification, when two elements are connected, it may be understood that the two elements are “connected” or “coupled” to each other by using one or more wires, cables, and/or printed electrical connections, or, as some non-restrictive and non-inclusive examples, by using electromagnetic energy having a wavelength in a radio frequency range, a microwave range, and/or an optical (both visible and invisible) range, or the like.

In the specification, the term “A and B are different” may mean that “A and B are different from each other”. The terms “separated”, “coupled”, and the like may also be similarly interpreted.

In the specification or claims, when “including”, “comprising”, and modifications of them are used, these terms are intended to be inclusive, as well as the term “having”. Furthermore, the term “or” that is used in the specification or claims is intended not to be exclusive disjunction (exclusive or).

The invention is described in detail above. It is apparent to persons skilled in the art that the present invention is not limited to the embodiments described in the specification. The present invention may be implemented as modes including alterations and modifications without departing from the spirit and scope of the present invention, which are determined based on the claims. Therefore, the specification is intended to provide illustrative description and does not provide any restrictive meaning on the present invention.

1. A user terminal comprising:
a receiving section that receives, via a downlink control channel, downlink control information that is used for scheduling of a physical shared channel; and
a control section that controls a process of receiving certain downlink control information based on a slot format and a candidate slot offset that is used to determine a slot in which the physical shared channel is transmitted.

2. The user terminal according to claim 1, wherein
the control section controls whether to monitor the certain downlink control information based on the slot format and the candidate slot offset at a monitoring occasion of the downlink control channel.

3. The user terminal according to claim 1, wherein
the control section controls interpretation of a slot offset designated by the certain downlink control information based on the slot format and the candidate slot offset at a monitoring occasion of the downlink control channel.

4. The user terminal according to claim 3, wherein
when there is no occasion of an uplink shared channel in a certain range corresponding to the candidate slot offset, the control section controls transmission of an uplink shared channel outside the certain range based on certain downlink control information received at the monitoring occasion.

5. The user terminal according to claim 1, wherein
the candidate slot offsets are multiple slot offsets that are configured by upper layer signaling.

6. A radio communication method for a user terminal, the radio communication method comprising:
a step of receiving, via a downlink control channel, downlink control information that is used for scheduling of a physical shared channel; and
a step of controlling a process of receiving certain downlink control information based on a slot format and a candidate slot offset that is used to determine a slot in which the physical shared channel is transmitted.

7. The user terminal according to claim 2, wherein
the candidate slot offsets are multiple slot offsets that are configured by upper layer signaling.

8. The user terminal according to claim 3, wherein
the candidate slot offsets are multiple slot offsets that are configured by upper layer signaling.

9. The user terminal according to claim 4, wherein
the candidate slot offsets are multiple slot offsets that are configured by upper layer signaling.
